(19) United States
(12) Patent Application Publication
(10) Pub. No.: US 2021/0291836 A1
(43) Pub. Date: Sep. 23, 2021

(54) VISION SYSTEM, VEHICLE HAVING THE SAME AND METHOD FOR CONTROLLING THE VEHICLE

(71) Applicant: MANDO CORPORATION, Pyeongtaek-si (KR)

(72) Inventor: Hanshin Cho, Seongnam-si (KR)

(21) Appl. No.: 17/205,260

(22) Filed: Mar. 18, 2021

(30) Foreign Application Priority Data
Mar. 19, 2020 (KR) 10-2020-0033694

(51) Int. Cl. B60W 40/04; G06K 9/00; G08G 1/16; G08G 1/0962; B60W 30/09; B60W 30/095

(52) U.S. Cl. CPC B60W 40/04; B60W 2552/53; G06K 9/00818; G06K 9/00825; G08G 1/166; G08G 1/0962; B60W 30/09; B60W 30/0956; B60W 30/0953; B60W 2540/10; B60W 2540/12; B60W 2554/4029; B60W 2554/80; B60W 2554/4042; B60W 2420/42; B60W 2554/20; B60W 2555/60; G06K 9/00805

(57) ABSTRACT

Provided is a vision system, vehicle including thereof, and a controlling method of the vehicle. The vision system includes a camera provided on a vehicle and having a front view of the vehicle outside, and configured to capture image data; and a controller having a processor configured to process the captured image data by the camera; and the controller may be configured to recognize an object existing in the front view based on the processed image data, determine whether the vehicle can depart based on information on the recognized object, control an output of departure availability notification or stop notification information corresponding to the determined departure availability.

### CROSS-REFERENCE TO RELATED APPLICATION

This application is based on and claims priority under 35 U.S.C. § 119 to Korean Patent Application No. 10-2020-0033694, filed on Mar. 19, 2020 in the Korean Intellectual Property Office, the disclosure of which is incorporated herein by reference.

### BACKGROUND

### 1. Field

The present disclosure relates to a vision system, vehicle having the same and method for controlling the same for guiding driving at an intersection.

### 2. Description of the Related Art

Recently, there have been development on various types of advanced driver assistance system (ADAS) that are designed to inform a driver of travelling information of a vehicle to prevent an accident from occurring due to driver's carelessness and perform autonomous driving for driver's convenience.

As an example, there is a technology that detects obstacles around the vehicle by mounting a distance sensor on the vehicle and warns the driver.

As another example, a distance to another vehicle is obtained through an electromagnet mounted on a bumper of a vehicle, and when the obtained distance to another vehicle is within a certain distance, it is determined as a collision situation. There is a technology that generates magnetic force by supplying power to an electromagnet, and thereby automatically brakes the vehicle in a collision situation

As another example, there is a vision technology that is provided in a vehicle and acquires an image around the vehicle and controls the driving of the vehicle based on the acquired image.

Despite the fact that the vehicle has a driver assistance system for driver safety and convenience, When a driver drives a vehicle, points that the driver should pay attention to should also change according to changes in surrounding conditions such as the width of the road, whether or not to turn, the amount of traffic, and the number of cyclists or pedestrians.

Accordingly, it is necessary to change driver assistance technology according to the surrounding situation. In particular, there is a need for a change in driver assistance technology that assists drivers in response to relationships with other vehicles or pedestrians while driving at an intersection or crosswalk.

### SUMMARY

An aspect provides a vision system, a vehicle having the same, and a control method thereof for outputting information on a driving possibility at an intersection or crosswalk based on driver intention information and acquired image information,

In accordance with one aspect of the present disclosure, a vision system includes a camera provided on a vehicle and having a front view of the vehicle outside, and configured to capture image data; and a controller having a processor configured to process the captured image data by the camera; and the controller may be configured to recognize an object existing in the front view based on the processed image data, determine whether the vehicle can depart based on information on the recognized object, control an output of departure availability notification or stop notification information corresponding to the determined departure availability.

The vision system may further include a communicator configured to receive a first pressure information on the pressure applied to an accelerator pedal, and a second pressure information on the pressure applied to a brake pedal, and the controller, after controlling the output of the departure availability notification information, may be configured to determine a departure intention of the vehicle based on the first pressure information and the second pressure information, and re-recognize the object based on the precessed image data when it is determined that there is the departure intention of the vehicle, and control the output of the stop notification information based on the information of the re-recognized object.

The vision system may further include a communicator configured to receive lever signal; and the controller may be configured to determine driving direction of the vehicle based on the received lever signal, and recognize the object based on the determined driving direction of the vehicle.

Information of the recognized object may include information on at least one of other vehicles, pedestrians, traffic lights, and traffic signs, and the controller may be configured to recognize an existence of the other vehicles and the pedestrians from the image data, recognize information on the traffic lights from the image data, and determine the traffic signs from information on the recognized traffic lights.

The controller may be configured to determine whether the other vehicle is existed in the front based on the information on the recognized object, determine whether the other vehicle in the front departs based on position change of the other vehicle in the front when it is determined that the other vehicle is existed in the front, control the output of departure availability notification information when it is determined that the other vehicle in the front is in the departure state.

The communicator may be configured to receive at least one of distance information from the other vehicle and speed information of the other vehicle, and the controller may be configured to determine whether the other vehicle departs based on at least one of received information.

The controller may be configured to control the output of the departure availability notification information based on the at least one information of traffic signals of the traffic signs and the pedestrians when the driving direction of the determined vehicle is a straight direction.

The controller may be configured to control the output of the departure availability notification information based on the at least one information of traffic signals of the traffic signs, the other vehicles, and the traffic signs when the driving direction of the determined vehicle is the left direction or the U-turn direction.

The controller may be configured to recognize information of the traffic signs from the image data, and determine a timing of the left turn and a timing of the U-turn from the information on the recognized traffic signs.

The controller may be configured to control the output of the departure availability notification information or attention notification information based on at least one information of the other vehicles and the pedestrians when it is determined that the driving direction of the determined vehicle is the right direction.

In accordance with another aspect of the present disclosure, a vehicle includes: a camera configured to capture image of road; a controller having a processor configured to process the captured image of road by the camera; and an output configured to output information corresponding to a control command of the processor, and the controller may be configured to recognize an object based on the image data of the processed image when in a stationary state, determine departure availability based on information on the recognized object, and control the output to output information corresponding to the departure availability.

The controller may be configured to determine the stationary state at an intersection or crosswalk based on at least one of navigation information and the image data.

The vehicle may further comprise a first pressure detector configured to output first pressure information by detecting pressure applied to an accelerator pedal; and a second pressure detector configured to output second pressure information by detecting pressure applied to a brake pedal; and the controller, after controlling the output of the departure availability notification information, may be configured to determine a departure intention of the vehicle based on the first pressure information and the second pressure information, and recognize the object based on the image data when it is determined that there is the departure intention of the vehicle, and control the output of the stop notification information based on whether the object is recognized.

The vehicle may further include a lever signal receiver configured to receive lever signal of the direction indicating lever, and the controller may be configured to determine the driving direction of the vehicle based on the received level signal, and recognize the object based on the determined driving direction information.

The object may include at least one of other vehicles, pedestrians, traffic lights, and traffic signs.

The output may be configured to include at least one of a display configured to display information corresponding to the departure availability as an image, and a sound output configured to output information corresponding to the departure availability as sound.

In accordance with another aspect of the present disclosure, a controlling method of a vehicle, recognizing an object based on captured image data by a camera when the vehicle is a stationary state; determining departure availability based on information of the recognized object; outputting information corresponding to the departure availability; determining whether to depart based on any one of first pressure information on the pressure applied to an accelerator pedal and second pressure information on the pressure applied to a brake pedal; recognizing the object based on the image data when it is determined that there is a departure intention, and outputting stop notification information based on whether the object is recognized.

Outputting information corresponding to the departure availability may include determining whether the other vehicle exists in front of the vehicle based on the recognized object information, determining whether the other vehicle in the front departs based on at least one of distance information from the other vehicle in the front and speed information of the other vehicle in the front when it is determined that there is the other vehicle in the front; and controlling the output of departure availability notification information when it is determined that the other vehicle in the front is in the departure state.

Outputting the information corresponding to the departure availability may include determining the driving direction of the vehicle based on the operation signal of the direction indicating lever; controlling the output of the departure availability notification information based on the traffic signal of a traffic light, information on other vehicles and traffic signs among the information on the recognized object when it is determined that the determined driving direction of the vehicle is the left direction or the U-turn direction; controlling the output of departure availability notification information or attention notification information based on information on the other vehicle and pedestrian among the information on the recognized object when it is determined that the determined driving direction of the vehicle is the right direction.

Determining the stationary state of the vehicle may include determining the stationary state at an intersection or crosswalk based on at least one of navigation information and the image data.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram illustrating a vehicle according to an embodiment.

FIG. 2 is a block diagram illustrating an advanced driver assistance system (ADAS) provided in a vehicle according to an embodiment.

FIG. 3 is a diagram illustrating an example of a detection area of a camera and a radar included in an ADAS of a vehicle according to an embodiment.

FIG. 4 is a block diagram of a notification apparatus among driver assistance systems provided in a vehicle according to an exemplary embodiment.

FIG. 5 is a flowchart illustrating a vehicle control according to an exemplary embodiment.

FIG. 6A, 6B, 7, 8, and 9 are exemplary views illustrating output control of notification information of a vehicle according to an embodiment.

### DETAILED DESCRIPTION

Like numerals refer to like elements throughout the specification. Not all elements of embodiments of the present disclosure will be described, and description of what are commonly known in the art or what overlap each other in the embodiments will be omitted.

The terms as used throughout the specification, such as part“, module”, member“, block”, etc., may be implemented in software and/or hardware, and a plurality of parts“, modules”, members“, or blocks” may be implemented in a single element, or a single part“, module”, member“, or block” may include a plurality of elements.

It will be further understood that the term “connect” or its derivatives refer both to direct and indirect connection, and the indirect connection includes a connection over a wireless communication network.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless the context clearly indicates otherwise.

In the specification, it should be understood that, when a member is referred to as being “on/under” another member, it can be directly on/under the other member, or one or more intervening members may also be present.

Although the terms “first,” “second,” “A,” “B,” etc. may be used to describe various components, the terms do not limit the corresponding components, but are used only for the purpose of distinguishing one component from another component.

Reference numerals used for method steps are just used for convenience of explanation, but not to limit an order of the steps. Thus, unless the context clearly dictates otherwise, the written order may be practiced otherwise.

Hereinafter, the operating principles and embodiments of the present disclosure will be described with reference to the accompanying drawings.

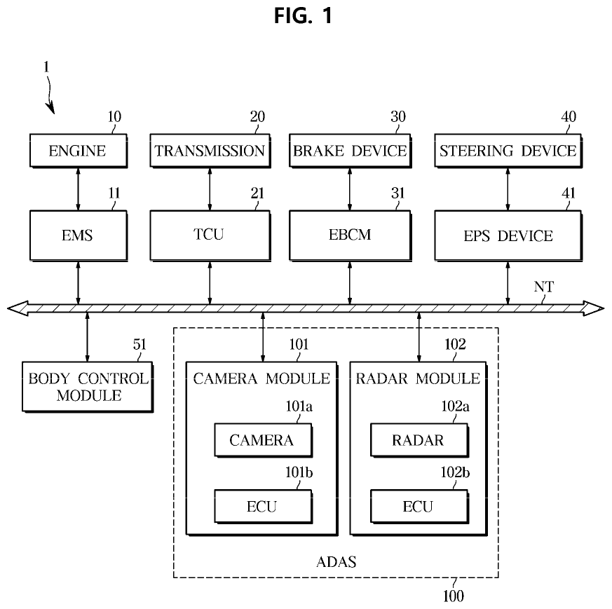

FIG. 1 is a block diagram illustrating a vehicle according to an embodiment.

A vehicle according to an embodiment may be a vehicle that performs a manual driving mode in which a driver drives in response to a driving intention and an autonomous driving mode in which autonomously travels to a destination.

The vehicle according to the present embodiment outputs information on the possibility of departure at an intersection or crosswalk when driving in the manual driving mode, or when driving in the autonomous driving mode, the vehicle may have a driver assistance system that controls driving based on the possibility of starting at an intersection or crosswalk.

Referring to FIG. 1, the vehicle 1 includes an engine 10, a transmission 20, a braking device 30, and a steering device 40.

The engine 10 may include a cylinder and a piston, and generate power for the vehicle 1 to travel.

The transmission 20 may include a plurality of gears, and transmit power generated by the engine 10 to wheels.

The braking device 30 may decelerate the vehicle 1 or stop the vehicle 1 through friction with the wheels.

The steering device 40 may change the travelling direction of the vehicle 1.

The vehicle 1 may include a plurality of electrical components.

For example, the vehicle 1 further includes an engine management system (EMS) 11, a transmission control unit (TCU) 21, and an electronic brake control module (EBCM) 31), an electronic power steering (EPS) 41, a body control module (BCM), and an advanced driver assistance system (ADAS).

The EMS 11 may control the engine 10 in response to acceleration intent of a driver through an accelerator pedal or a request of an advanced driver assistance system (ADAS) 100. For example, the EMS 11 may control the torque of the engine 10.

The TCU 21 may control the transmission 20 in response to a shift command of the driver through a shift lever and/or a travelling velocity of the vehicle 1. For example, the TCU 21 may adjust the gear ratio from the engine 10 to the vehicle wheels.

The EBCM 31 may control the braking device 30 in response to a braking intent of a driver through a braking pedal and/or a slip of the vehicle wheels. For example, the EBCM 31 may temporarily release the braking of the vehicle wheel in response to a slip of the vehicle wheel sensed at a time of braking of the vehicle 1 (anti-lock braking systems, ABS).

The EBCM 31 may selectively release braking of the vehicle wheel in response to over-steering and/or under-steering sensed at a time of steering of the vehicle 1 (electronic stability control, ESC).

In addition, the EBCM 31 may temporarily brake the vehicle wheels in response to a slip of the vehicle wheel sensed at a time of driving of the vehicle 1 (traction control system, TCS).

The EPS 41 may assist the operation of the steering device 40 so that the driver easily manipulates the steering wheel, in response to a steering intent of the driver through the steering wheel. For example, the EPS 41 may assist the operation of the steering device 40 such that the steering force is reduced during low-velocity traveling or parking and is increased during high-velocity traveling.

The BCM 51 may control the operation of the electronic components that provide convenience to the driver or ensure the safety of the driver. For example, the BCM 51 may control a head lamp, a wiper, a cluster, a multifunction switch, a turn signal lamp, and the like.

The ADAS 100 may assist the driver in manipulating (driving, braking, steering) the vehicle 1. For example, the ADAS 100 may detect a surrounding environment (e.g., another vehicle, a pedestrian, a cyclist, a lane, a road sign, etc.) around the vehicle 1 and control the driving and/or braking and/or steering of the vehicle 1 in response to the sensed surrounding environment.

The ADAS 100 may provide the driver with various functions. For example, the DAS 60 may provide a lane departure warning (LDVV), a lane keeping assist (LKA), a high beam assist (HBA), an autonomous emergency braking (AEB), a traffic sign recognition (TSR), a smart cruise control (SCC), a blind spot detection (BSD), and vision system, and the like.

ADAS 100 may include an autonomous driving control device that automatically drives to a destination by controlling the vehicle's driving according to a planned driving route while avoiding obstacles, determining the road environment and determining obstacles and driving conditions.

The driver assistance system 100 may include a Lead Vehicle Departure Alert (LVDA) that determines the possibility of departure when stopping at an intersection or crosswalk and outputs information on the determined departure availability.

The ADAS 100 may include a camera module 101 for acquiring image data around the vehicle 1 and a radar module 102 for acquiring obstacle data around the vehicle 1.

The camera module 101 may include a camera 101a and an electronic control unit (ECU) 101b, and may photograph the front of the vehicle 1 and recognize other vehicles, pedestrians, cyclists, lanes, road signs, and the like.

The radar module 102 may include a radar 102a and an electronic control unit (ECU) 102b and may acquire relative positions and relative velocities of obstacles (e.g., other vehicles, pedestrians, cyclists, and the like) around the vehicle 1.

The above described electronic components may communicate with each other through vehicle communication network (NT). For example, the electrical components may exchange data therebetween through Ethernet, media oriented systems transport (MOST), Flexray, controller area network (CAN), local interconnect network (LIN), and the like.

ADAS 100 may transmit a drive control signal, a braking control signal, and a steering control signal to the engine management system 11, the electronic braking control module 31, and the electronic steering control device 41, respectively, through the vehicle communication network NT.

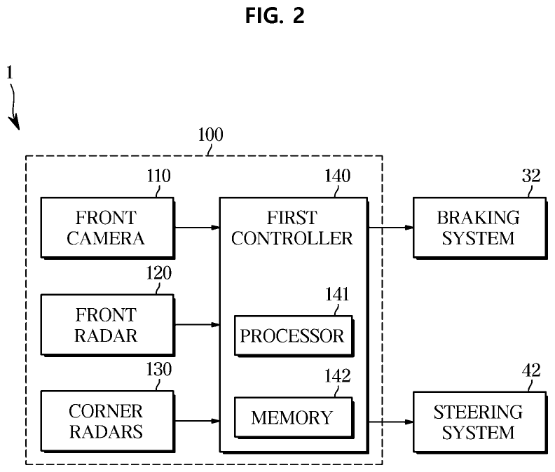

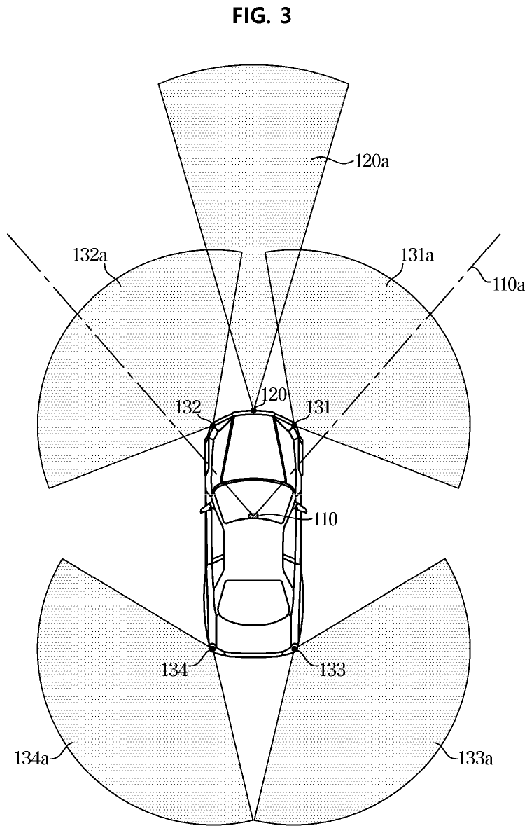

FIG. 2 is a block diagram illustrating an ADAS provided in a vehicle according to an embodiment, and FIG. 3 is a diagram illustrating an example of a detection area of a camera and a radar included in an ADAS of a vehicle according to an embodiment.

The driver assistance system of this embodiment includes a Lead Vehicle Departure Alert (LVDA) determining the possible departure time or possibility of departure, and outputting information on the determined possible departure time and departure

Referring to FIG. 2, the vehicle 1 may include a braking system 32, a steering system 42, and a ADAS 100.

The braking system 32 according to the embodiment may include the EBCM (31 in FIG. 1) and the braking device (30 in FIG. 1) described in conjunction with FIG. 1, and the steering system 42 may include the EPS (41 in FIG. 1) and the steering device (40 in FIG. 1).

The ADAS 100 according to the embodiment may include a front camera 110, a front radar 120, and the plurality of corner radars 130: 131, 132, 133, 134.

As shown in FIG. 3, the front camera 110 may have a field of view 110a facing forward of the vehicle 1.

The front camera 110 may be installed, for example, in the front windshield of the vehicle 1.

The front camera 110 may photograph the front of the vehicle 1 and acquire image data regarding the front of the vehicle 1. The image data regarding the front of the vehicle 1 may include position information of at least one of another vehicle, a pedestrian, a cyclist, a lane, a curb, a guard rail, a roadside tree, a street lamp, or the like existing in front of the vehicle 1.

The front camera 110 may include a plurality of lenses and an image sensor. The image sensor may include a plurality of photodiodes for converting light into electrical signals, and the plurality of photodiodes may be arranged in a two-dimensional matrix.

The front camera 110 may be electrically connected to a first controller 140. For example, the front camera 110 may be connected to the first controller 140 through a vehicle communication network NT, through a hard wire, or through a printed circuit board (PCB).

The front camera 110 may transmit the image data of the front of the vehicle 1 to the first controller 140.

The front radar 120 may have a field of sensing 120a facing the front of the vehicle 1. The front radar 120 may be installed, for example, on a grille or bumper of the vehicle 1.

The front radar 120 may include a transmission antenna (or a transmission antenna array) that radiates transmission radio waves to the front of the vehicle 1 and a reception antenna (or a reception antenna array) that receives reflection radio waves reflected from an obstacle.

The front radar 120 may acquire front radar data from the transmission radio waves transmitted by the transmission antenna and the reflection radio waves received by the reception antenna.

Front radar data may include position information and velocity information regarding an obstacle, such as another vehicle, a pedestrian, or a cyclist existing in front of the vehicle 1.

The front radar 120 may calculate the relative distance to the obstacle based on the phase difference (or time difference) between the transmission radio waves and the reflection radio waves, and calculate the relative velocity of the object based on the frequency difference between the transmission radio waves and the reflected radio waves.

The front radar 120 may be connected to the first controller 140 through a vehicle communication network NT, a hard wire, or a printed circuit board. The front radar 120 may transmit the front radar data to the first controller 140.

The plurality of corner radars 130 includes a first corner radar 131 installed on the front right side of the vehicle 1, a second corner radar 132 installed on the front left side of the vehicle 1, a third corner radar 133 installed on the rear right side of the vehicle 1, and a fourth corner radar 134 installed on the rear left side of the vehicle 1.

The first corner radar 131 may be installed on the right side of a front bumper of the vehicle 1.

The second corner radar 132 may have a field of sensing 132a directed to the front left side of the vehicle 1, and may be installed on the left side of the front bumper of the vehicle 1.

The third corner radar 133 may have a field of sensing 133a directed to the rear right side of the vehicle 1 and may be installed on the right side of a rear bumper of the vehicle 1.

The fourth corner radar 134 may have a field of sensing 134a directed to the rear left side of the vehicle 1 and may be installed on the left side of the rear bumper of the vehicle 1.

Each of the first, second, third and fourth corner radars 131, 132, 133, and 134 may include a transmission antenna and a reception antenna.

The first, second, third, and fourth corner radars 131, 132, 133 and 134 acquire first corner radar data, second corner radar data, third corner radar data, and fourth corner radar data, respectively.

The first corner radar data may include distance information and velocity information regarding another vehicle, a pedestrian or a cyclist (hereinafter, referred to as “an obstacle”) existing on the front right side of the vehicle 1.

The second corner radar data may include distance information and velocity information regarding an obstacle existing on the front left side of the vehicle 1.

The third and fourth corner radar data may respectively include distance and velocity information regarding an obstacle existing on the rear right side of the vehicle 1 and distance and velocity information regarding an object located on the rear left side of the vehicle 1, respectively.

Each of the first, second, third, and fourth corner radars 131, 132, 133 and 134 may be connected to the first controller 140, for example, through a vehicle communication network NT, a hard wire, or a printed circuit board. The first, second, third, and fourth corner radars 131, 132, 133, and 134 may respectively transmit the first corner radar data, the second corner radar data, the third corner radar data, and the fourth corner radar data to the first controller 140.

The first controller 140 may include the ECU (101b in FIG. 1) of the camera module (101 in FIG. 1) and/or the ECU (102b in FIG. 1) of the radar module (102 in FIG. 1), and/or an integrated ECU.

The first controller 140 includes a processor 141 and a memory 142.

The processor 141 may process the front image data of the front camera 110, the front radar data of the front radar 120, and the corner radar data of the plurality of corner radars 130, and generate a braking signal and a steering signal for controlling the braking system 32 and the steering system 42.

For example, the processor 141 may include an image signal processor for processing the front image data of the front camera 110 and/or a digital signal processor for processing radar data of the radars 120 and 130 and/or a micro control unit (MCU) for generating a braking signal and/or a steering signal.

The processor 141 may detect obstacles (e.g., another vehicle, a pedestrian, a cyclist, a curb, a guard rail, a roadside tree, a street lamp, and the like) in front of the vehicle 1 based on the front image data of the front camera 110 and the front radar data of the radar 120.

In detail, the processor 141 may acquire position information (distance and direction) and velocity information (relative velocity) of the obstacles in front of the vehicle 1 based on the front radar data of the front radar 120. The processor 141 may acquire position information (direction) and type information (for example, whether the obstacle is another vehicle, a pedestrian, a cyclist, a cub, a guard rail, a roadside tree, a street lamp, or the like) of the obstacle existing in front of the vehicle 1 based on the front image data of the front camera 110.

In addition, the processor 141 may match the obstacles detected by the front image data with the obstacles detected by the front radar data, and acquire the type information, the position information, and the velocity information of the obstacles in front of the vehicle 1 based on a result of the matching.

The processor 141 may generate a braking signal and a steering signal based on the type information, the position information, and the velocity information of the front obstacles.

For example, the processor 141 calculates a time to collision (TTC) between the vehicle 1 and the front obstacle based on the position information (relative distance) and the velocity information (relative velocity) of the front objects, and warns the driver of a collision, transmits a braking signal to the braking system 32, or transmits a steering signal to the steering system 42 based on a result of comparing the TTC with a predetermined reference time.

In response to the TTC less than a predetermined first reference time, the processor 141 may allow an alert to be output via audio and/or display.

In response to the TTC less than a predetermined second reference time, the processor 141 may transmit a preliminary-braking signal to the braking system 32.

In response to the TTC less than a predetermined third reference time, the processor 141 may transmit an emergency braking signal to the braking system 32. In this case, the second reference time is shorter than the first reference time, and the third reference time is shorter than the second reference time.

The processor 141 may transmit a steering signal to the steering system 42 based on direction information among position information of front obstacles.

As another example, the processor 141 may calculate a distance to collision (DTC) based on the velocity information (relative velocity) of front objects, and warn the driver of a collision or transmit a braking signal to the braking system 32 based on a result of comparing the DTC with distances to the front objects.

The processor 141 may acquire position information (distance and direction) and velocity information (relative velocity) of the obstacles on the sides of the vehicle 1 (front right, front left, rear right, and rear left) based on corner radar data of the plurality of corner radars 130.

The memory 142 may store programs and/or data for processing image data by the processor 141, programs and/or data for processing radar data by the processor 141, and programs and/or data for generating a braking signal and/or a steering signal by the processor 141.

The memory 142 may temporarily memorize the image data received from the front camera 110 and/or the radar data received from the radars 120 and 130, and may temporarily memorize a result of processing the image data and/or the radar data of the processor 141.

The memory 142 may not only include a volatile memory, such as an S-RAM, a D-RAM, and the like, but also include a non-volatile memory, such as a flash memory, a read only memory (ROM), an erasable programmable read only memory (EPROM), and the like.

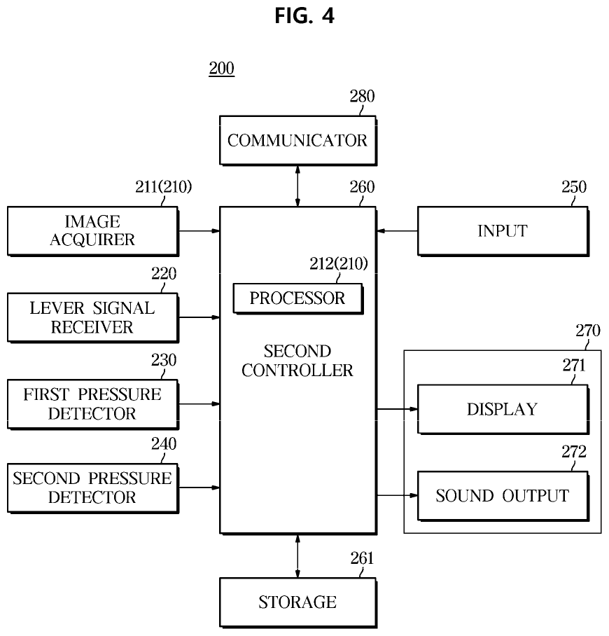

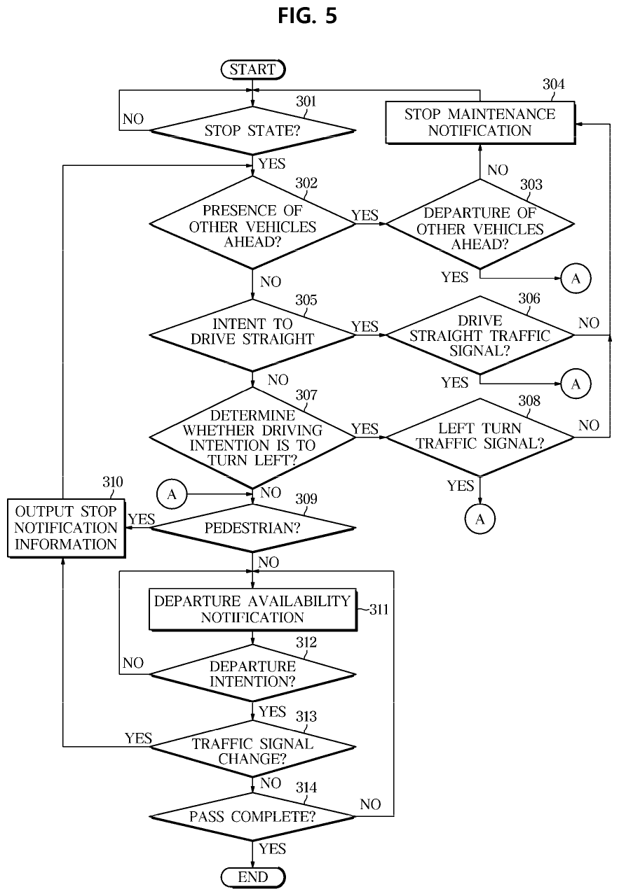

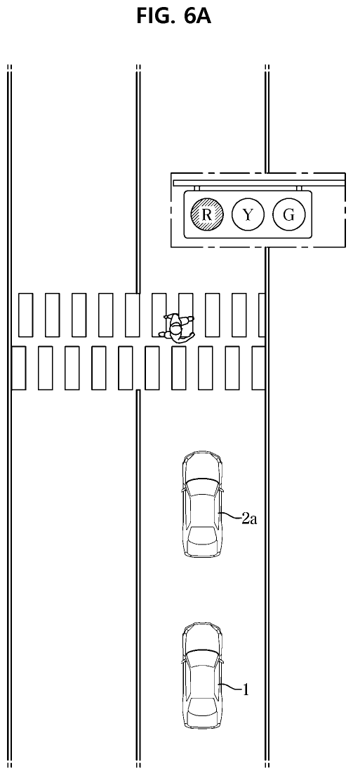

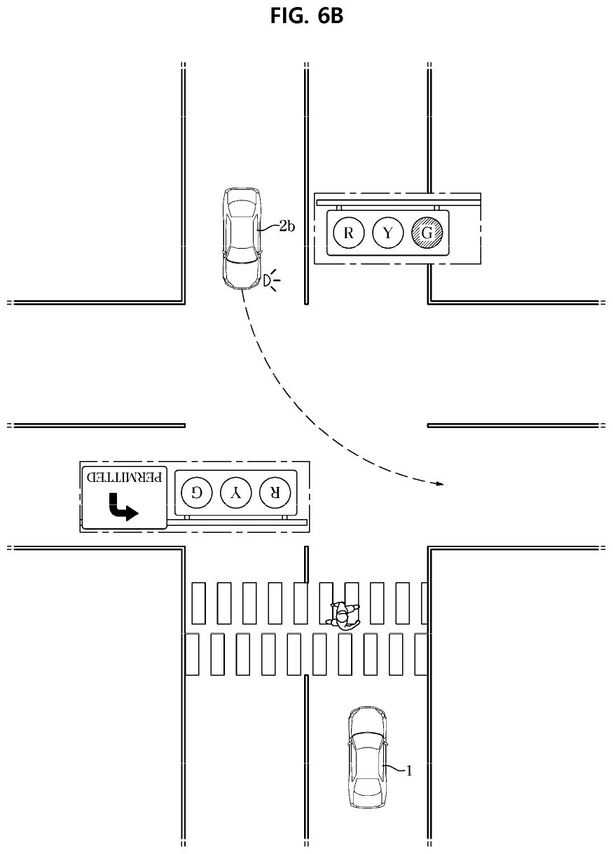

FIG. 4 is a control configuration diagram of a vision system 210 and a notification device 200 communicating with the vision system 210 among driver assistance systems 100 provided in a vehicle according to an exemplary embodiment.

The vision system 210 includes an image acquirer 211 and a processor 212.

The image acquirer 211 may photograph the front of the vehicle 1 and acquire image data of the front of the vehicle 1. The image data in front of the vehicle 1 includes an Image information on at least one object among other vehicles, pedestrians, cyclists, traffic lights, and traffic signs located in front of the vehicle 1, and location information on the recognized object.

The image acquirer 211 may include a camera, and the camera may include a plurality of lenses and an image sensor. The image sensor may include a plurality of photodiodes that convert light into electrical signals, and the plurality of photodiodes may be arranged in a two-dimensional matrix.

The processor 212 processes the image data acquired by the image acquisition unit 211.

The processor 212 may transmit image data to the second controller 260.

In addition, the processor 212 recognizes at least one object among other vehicles, pedestrians, cyclists, traffic lights, and traffic signs located in front of the vehicle 1 from the image data in front of the vehicle 1, and transmits information on the recognized object to the second controller 260.

In addition, the processor 212 recognizes at least one object among other vehicles, pedestrians, cyclists, traffic lights, and traffic signs located in front of the vehicle 1 from the image data in front of the vehicle 1, and controls an output of any one of driving possibility notification information, stop notification information, and attention notification information of the vehicle based on information on the recognized object.

The processor 212 receives information on the driver's driving intention and controls the output of any one of driving possibility notification information, stop notification information, and attention notification information of the vehicle based on the received driving intention information and the recognized object information.

The second controller 260 recognizes an object based on image data, or performs a function of the processor 212 that controls the output of notification information based on information on driving intention and information on the recognized object.

The processor 212 may be electrically connected to the second controller 260. For example, the processor 212 is connected to the second controller 260 through a vehicle communication network (NT), a second controller 260 through a hard wire, or a printed circuit board (PCB).

In this way, the processor 212 may be provided separately from the second controller 260.

In addition, the processor 212 may be provided integrally with the second controller 260.

Among ADAS 100, notification apparatus 200 includes lever signal receiver 220, first pressure detector 230, second pressure detector 240, input 250, second controller 260, storage 261, output 270, and communicator 280.

The lever signal receiver 220 is connected to the direction indicating lever and receives the operation signal of the direction indicating lever.

The direction indicating lever is provided around the steering wheel and can be operated by the driver in response to the driver's driving intention, and outputs a signal corresponding to the operation.

The direction indicating lever may be operated in the first direction in response to the driving intention of turning left or in the second direction in response to the driving intention of turning right.

The left turn indication lamp may be turned on or the right turn indication lamp may be turned on by the movement of the direction indication lever, and both the left turn indication lamp and the right turn indication lamp may be turned off by the direction indication lever positioned at the original position.

In addition, the notification apparatus may receive an ON signal and an OFF signal of the left turn indication lamp, and an ON signal and an OFF signal of the right turn indication lamp as signals corresponding to the driver's driving intention.

The first pressure detector 230 detects the pressure applied to the accelerator pedal and outputs information (ie, first pressure information) corresponding to the detected pressure. Here, the accelerator pedal may be pressed or released in response to the drivers driving intention.

The second pressure detector 240 detects the pressure applied to the brake pedal and outputs information corresponding to the detected pressure (ie, second pressure information). Here, the brake pedal may be pressurized or released in response to the drivers driving intention.

Here, the first pressure detector 230 and the second pressure detector 240 may be provided in the notification apparatus 200.

In addition, the first pressure detector 230 and the second pressure detector 240 are provided in the vehicle, but are provided separately from the notification device, and it is possible to communicate with the notification apparatus 200 through communication. In this case, the notification device may receive the first and second pressure information.

The input 250 receives user input.

The input 250 may receive an on/off command of a notification function performed by the notification device.

The input 250 may receive destination information while performing an autonomous driving mode or a navigation mode, and may receive information of a route for at least one of a plurality of routes.

The input 250 may receive an operation command for any one of the functions that can be performed in the vehicle.

For example, the input 250 may receive an operation command of at least one of a radio function, an audio function, a video function, a map display function, a navigation function, a DMB function, a content playback function, and an Internet search function.

The input 250 may be provided in the notification apparatus 200, may be provided in the head unit or center fascia of the vehicle, or may be provided in the vehicle terminal. The input 250 may be provided with buttons, keys, switches, operation levers, jog dials, etc., or may be provided with a touch pad.

The second controller 260 recognizes an object present in the front field of view in the image acquired based on the image data acquired by the image acquirer 211, determines the departure availability of the vehicle based on the information on the recognized object, and controls output of departure availability notification information, stop maintenance notification information, stop notification information, and attention notification information corresponding to the determined departure availability.

The second controller 260 may also acquire location information and speed information of an object from image data captured by the camera. Here, the object may include other vehicles, pedestrians, traffic signs, and traffic lights, and a pedestrian may be a pedestrian crossing a road, may be a cyclist, or may be a personal mobility user.

The second controller 260 determines whether other vehicles or pedestrians exist in the image based on object information recognized by the image data, recognizes information on signs of traffic signs, and recognizes traffic signals such as traffic lights.

The second controller 260 controls the output of the departure availability notification information, and then determines whether there is an intention to start the vehicle based on the first pressure information or the second pressure information, re-recognizes the object based on the image data when it is determined that there is an intention to start the vehicle, and controls the output of stop notification information based on information on the re-recognized object.

The second controller 260 determines whether the driver intends to accelerate based on the first pressure information detected by the first pressure detector, and determines that the departure intention exists when it is determined that the driver's acceleration intention exists.

The second controller 260 determines whether the driver intends to release the brake based on the pressure information detected by the second pressure detector, and determines that there is an intention to depart when it is determined that the driver's intention to release the brake exists.

The second controller 260 determines a driving direction corresponding to a driving intention based on the received lever signal and recognizes an object based on the determined driving direction of the vehicle.

The second controller may determine a driving intention to turn left, turn right, or go straight on the basis of the lever signal received by the lever signal receiver. In addition, the second controller may determine the driving intention of turning left, turning right, or going straight on the basis of whether a left direction indication or a right direction indication is lit.

The second controller 260 determines whether there is another vehicle in front based on the information on the recognized object, determines whether another vehicle in front starts based on the change in the position of the object in the image when the second controller 260 determines that there is another vehicle in front, and controls the output of departure possible notification information When it is determined that the other vehicle in front has started.

The notification apparatus may further include an obstacle detector (not shown) for detecting a distance to a pedestrian or other vehicle. In this case, the second controller 260 may determine whether another vehicle in front starts based on information on the distance to the obstacle detected by the obstacle detector.

The second controller 260 acquires speed information of another vehicle in front based on the change in distance information from the obstacle detected by the obstacle detector and determines whether another vehicle in front starts based on the obtained speed information of another vehicle in front.

Here, the obstacle detector detects obstacles in the front and left and right sides of the own vehicle, and transmits obstacle information about the detected obstacle to the second controller 260. Here, the obstacle information may include position information of the obstacle, and the position information of the obstacle may include a distance to the obstacle and a direction of the obstacle.

Such an obstacle detector may include a front radar 120 and first and second corner radars 131 and 132. In addition, the obstacle detector may include a lidar sensor. The LiDAR (Light Detection And Ranging) sensor is a non-contact distance detection sensor using the principle of laser radar. The lidar sensor may include a transmitter that transmits a laser, and a receiver that receives a laser that returns after being reflected on a surface of an object existing within the sensor range. The obstacle detector may also include an ultrasonic sensor.

The second controller 260 determines whether there is another vehicle in front based on the information on the recognized object, determines whether another vehicle is starting when it is determined that there is another vehicle in front, checks the traffic signal of the traffic light in the video and the driving direction of the vehicle corresponding to the driving intention when it is determined that another vehicle has started, and controls the output of the departure availability notification information based on the confirmed driving direction of the vehicle and a traffic signal.

If the second controller 260 determines that it is possible to depart, it checks whether a pedestrian or other vehicle exists in the direction to be driven. The second controller 260 controls the output of stop notification information when it is determined that a pedestrian or other vehicle exists. When it is determined that no pedestrian or other vehicle exists, the second controller 260 controls the output of departure availability notification information.

The second controller 260 determines the driving direction of the vehicle corresponding to the driving intention based on the received lever signal, checks the presence of a traffic signal of a traffic light and a pedestrian in the image based on the recognized object information when it is determined that the driving direction of the vehicle is a straight direction, controls the output of notification information about the possibility of departure when the confirmed traffic signal is a straight signal (green lamp is lit) and no pedestrian exists, and controls the output of stop notification information when the confirmed traffic signal is not a straight signal (green lamp is lit) or a pedestrian exists.

When it is determined that the driving direction of the vehicle corresponding to the driving intention is the left direction or the U-turn direction, the second controller 260 recognizes the traffic signal of the traffic light in the image, the presence of other vehicles, and the mark information of the traffic sign, and controls the output of the departure availability notification information based on the recognized traffic signal of the traffic light, the presence of other vehicles, and mark information of the traffic sign.

The second controller 260 may recognize information on a traffic sign from the image data and determine the timing of the left turn and the timing of the U-turn from the recognized traffic sign information.

When it is determined that the driving direction of the vehicle corresponding to the driving intention is the right direction, the second controller 260 recognizes the existence of pedestrians and other vehicles in the image, and controls the output of the departure availability notification information or the attention notification information based on the presence or absence of the recognized pedestrians and other vehicles.

The second controller 260 determines whether an image of a pedestrian exists in the acquired image based on the image data acquired by the image acquirer, and recognizes pedestrian information about the pedestrian when it is determined that an image of a pedestrian exists in the acquired image.

The second controller 260 determines whether an image for a traffic sign exists in the image acquired based on the image data acquired by the image acquirer, and when it is determined that the image for the traffic sign exists in the acquired image, the second controller 260 recognizes the sign information for the traffic sign.

Here, the sign information of the traffic sign may include information on an permitted left turn mark, a left turn mark, a U-turn mark, and a P-turn mark, and may include timing information about a left turn time and a U-turn time.

The second controller 260 determines whether an image for a traffic light exists in the acquired image based on the image data acquired by the image acquirer, and recognizes traffic signal information for a traffic signal when it is determined that an image of a traffic light exists in the acquired image.

Here, the traffic signals include red, green, yellow signals, left turn signals, U-turn signals, and flashing signals.

The second controller 260 generates a route from the current location to the destination and controls driving with the generated route based on the current location information and destination information received by the location receiver in the navigation mode or autonomous driving mode

When a plurality of routes are generated, the second controller 260 may control driving based on information on a route selected by the input 250 among the plurality of routes.

The second controller 260 may control the display 271 to generate navigation information by matching the generated route information and current location information with map information, and display the generated navigation information.

The vehicle further comprises a braking system 32 and a steering system 42. In this case, the second controller 260 may also communicate with the braking system 32 and the steering system 42.

The braking system 32 may perform braking in response to a braking signal of the second controller 260 to prevent a collision with other vehicles or pedestrians.

The braking system 32 may also perform emergency braking based on the braking signal of the second controller 260.

The steering system 42 may perform steering to adjust a driving route in response to a steering signal from the second controller 260.

The storage 261 stores image information of an object for recognizing an object. Here, the object may include image information on traffic lights, traffic signs, pedestrians, cyclists, and vehicles.

The storage 261 stores image information and notification sound information corresponding to departure availability notification information, stop notification information, and attention notification information, respectively.

The storage 261 can store map information.

This storage 261 may be implemented with at least one of Non-volatile memory devices such as Programmable ROM (PROM), Erasable Programmable ROM (EPROM), Electrically Erasable Programmable ROM (EEPROM), and Flash memory, Cache, read only memory (ROM), or Non-volatile memory devices such as Programmable ROM (PROM), Erasable Programmable ROM (EPROM), Electrically Erasable Programmable ROM (EEPROM), and Flash memory or a volatile memory device such as random access memory (RAM), or a storage medium such as a hard disk drive (HDD, Hard Disk Drive) but is not limited thereto.

The storage 261 may be a memory implemented as a separate chip from the processor described above with respect to the second controller 260, or may be implemented as a processor and a single chip.

The output 270 may include a display 271 that displays information on departure availability as an image, and a sound output 272 that outputs information on departure availability as sound.

The display 271 displays operation information on a function being performed by the notification apparatus 200.

The display 271 may change the background color in response to a control command of the second controller 260. The display 271 displays an image of any one of departure availability notification information, stop notification information, and attention notification information in response to a control command of the second controller 260. Here, the background color may be different from each other in correspondence with departure availability notification information, stop notification information, and attention notification information.

The display 271 may be provided inside the vehicle, and in this case, the display unit 271 displays operation information for a function being performed in the vehicle. For example, the display 271 displays information related to a phone call, or displays information of content output through the terminal (1% 0), or also displays information related to music reproduction and display external broadcast information.

The display 271 may display map information, and may display map information matching a route to a destination and route guidance information.

If there are a plurality of routes to the destination, the display 271 may display the travel time and the travel distance corresponding to each route to facilitate selection by the user.

The display 271 may display an image of a road or display location information of a pedestrian.

The display 271 may be a lamp such as an LED or a flat panel display device such as an LCD.

The display 271 may be a display panel to be provided in a vehicle terminal.

The display 271 may be provided integrally with the input 250. In this case, the display 271 may include a flat panel display, and the input 250 may include a touch panel integrally provided with the flat panel display panel.

The sound output 272 outputs operation information on a function being performed by the notification apparatus 200 as sound.

The sound output 272 may change the notification sound in response to a control command of the second controller 260.

The sound output 272 outputs a notification or a notification voice for any one of departure availability notification information, stop notification information, and attention notification information in response to a control command of the second controller 260.

This sound output 272 may be a speaker.

The sound output 272 can also output information on a function being performed in the vehicle as sound. For example, the sound output 272 may output navigation information as sound when a navigation function is performed in a vehicle.

The sound output 272 may be provided in the notification apparatus 200, may be provided in a head unit or a center fascia built into a vehicle, or may be provided in a vehicle terminal.

The vehicle may further include a rotation speed detector (not shown) that detects the rotation speed of the engine and a pressure detector that detects the pressure of the master cylinder.

In this case, the notification apparatus may receive information on the number of rotations detected by the number of rotation detector through the communicator (number of rotation information) and pressure information of the master cylinder, determines a driving intention related to acceleration based on the received rotation speed information, determines a driving intention related to braking or deceleration based on the pressure information of the master cylinder, and determines the driver's departure intention based on the rotation speed information and the pressure information of the master cylinder while outputting the departure availability notification information.

The communicator 280 performs communication between the image acquirer and the second controller, a lever signal receiver, a first pressure detector, and a second controller and at least one of the first and second pressure detector.

The communicator 280 performs communication between the input and the second controller, and communication between the output and the second controller.

The communicator 280 may include a location receiver.

Here, the location receiver may receive location information of the own vehicle and transmit the received location information to the second controller 260.

The location receiver may include a Global Positioning System (GPS) receiver that communicates with a plurality of satellites and calculates the location of the own vehicle.

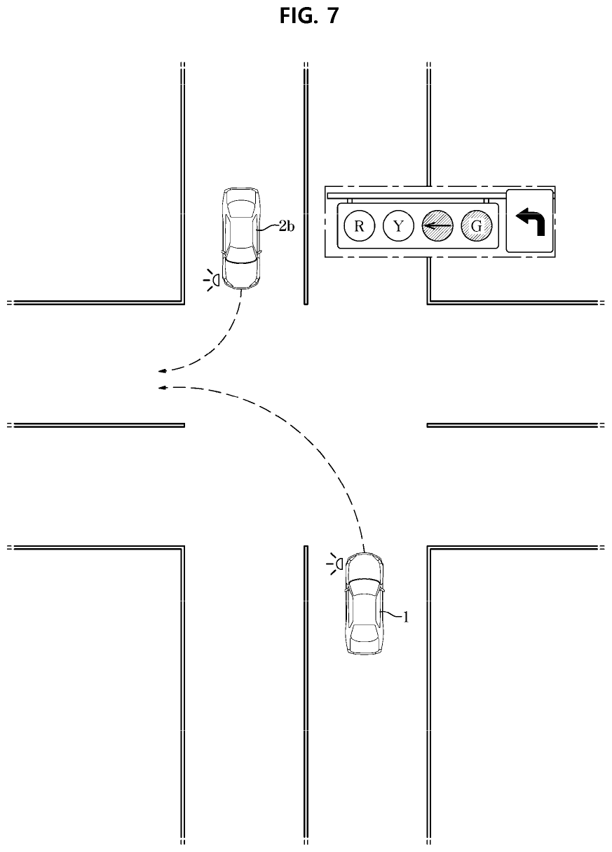

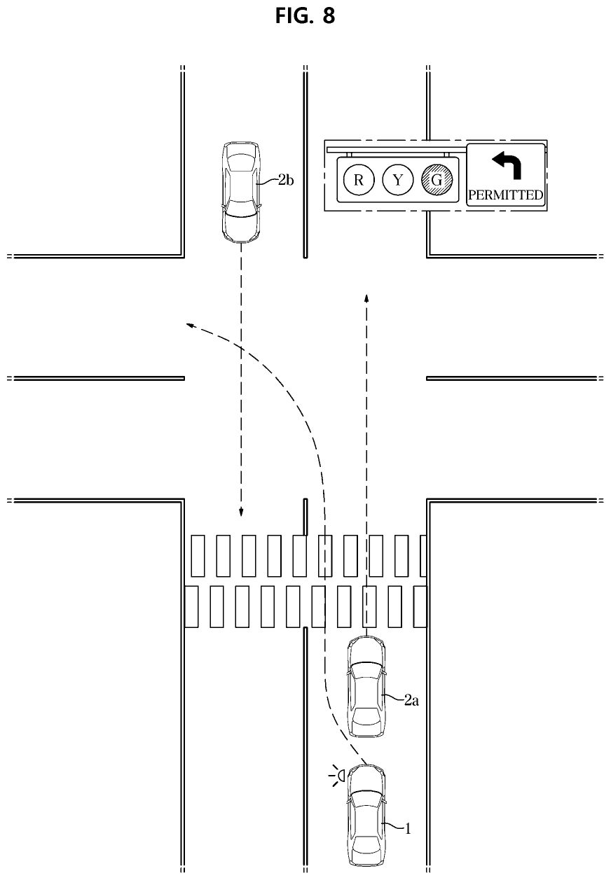

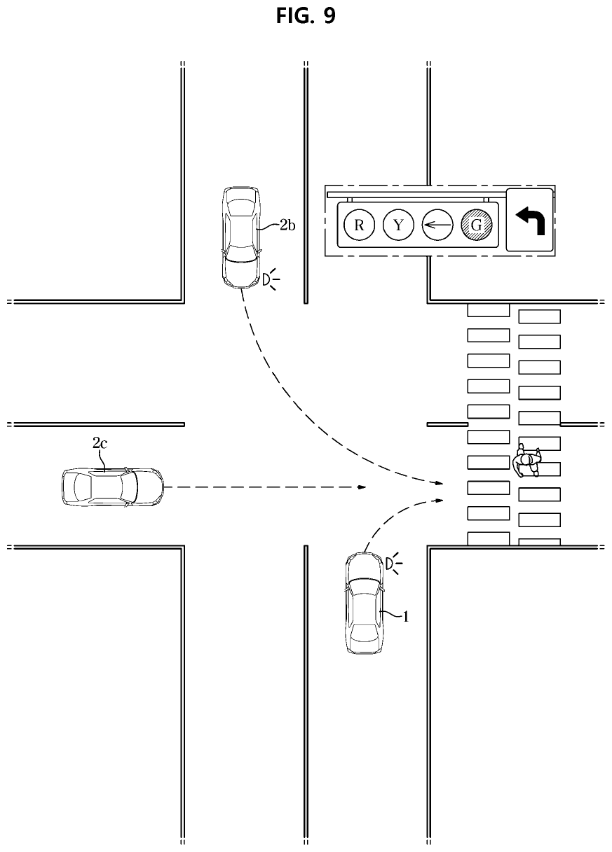

FIG. 5 is a flowchart illustrating a vehicle control according to an exemplary embodiment. FIGS. 6A, 6B, 7, 8, and 9 are exemplary views illustrating output control of notification information of a vehicle according to an embodiment.

It is determined (301) whether the vehicle is stopped at an intersection or crosswalk.

Determining whether it is stationary at an intersection or crosswalk, includes determining whether the driving speed of the vehicle is zero based on the speed information detected by the speed detector or determining whether the position of the shift lever is at a neutral stage, and when it is determined that the vehicle's running speed is zero or the position of the shift lever is at the neutral stage, based on the navigation information and the current location information, determining whether the point where the vehicle is currently stopped in a standstill is an intersection point or a crosswalk point.

Determining whether it is stationary at an intersection or crosswalk, includes when it is determined that the driving speed of the vehicle is zero or the position of the shifting lever is at the neutral stage, processing the image data acquired by the image acquirer, determining whether there is an intersection image or a crosswalk image in the image based on the processed image data, it is determined, and determining whether an intersection image or a crosswalk image exists in the image.

Determining whether it is stationary at an intersection or crosswalk, includes checking the operation signal of the lever when it is determined that the vehicle's running speed is zero or the position of the shifting lever is at the neutral stage, and determining whether the stopped point is an intersection point or a crosswalk when the confirmed lever operation signal is a signal manipulated in the left or right direction.

When the next vehicle determines that the current state is a stationary state, the image acquirer 211 recognizes an object existing in the front view in the image acquired based on the image data acquired.

Here, the object may include other vehicles, pedestrians, traffic signs, and traffic lights, and the pedestrian may be a pedestrian crossing a road, a cyclist list, or a personal mobility user.

The vehicle determines whether other vehicles or pedestrians exist in the image based on object information recognized by the image data, recognizes information on signs of traffic signs, and recognizes traffic signals such as traffic lights.

In the vehicle, when the object is a pedestrian or another vehicle, it is also possible to obtain position information and speed information of the object from image data.

More specifically, the vehicle determines whether an image of a pedestrian exists in the image acquired based on the image data acquired by the image acquirer 211, recognizes the location information and speed information of the pedestrian about the pedestrian when it is determined that an image of a pedestrian exists in the acquired image.

The vehicle determines whether an image of a traffic sign exists in the acquired image based on the image data acquired by the image acquirer 211, and recognizes the sign information for the traffic sign when it is determined that the image of the traffic sign exists in the acquired image.

Here, the sign information of the traffic sign may include information on an permitted left turn mark, a left turn mark, a U-turn mark, a P-turn mark, a left turn impossible mark, and a U-turn impossible mark, and may include timing information on the left turn timing and the U-turn timing.

The vehicle determines whether an image of a traffic light exists in the acquired image based on the image data acquired by the image acquirer 211, and recognizes traffic signal information about the traffic signal when it is determined that the image of the traffic light exists in the acquired image.

Here, the traffic signals includes red signals (stop traffic signals), green signals (straight traffic signals), yellow signals (stop ready traffic signals), left turn signals (left turn traffic signals), U-turn signals (diagonal arrows, U-turn traffic signals), and flashing signals (attention traffic signals).

The vehicle determines whether there is another vehicle in front based on information on the recognized object in the image (302), determines whether another vehicle in front has started based on a change in the location information of the object recognized in the image when it is determined that another vehicle is present in the front (303).

When determining whether another vehicle is starting, it is also possible for the vehicle to determine whether another vehicle in front has started based on information about the distance to the obstacle detected by the obstacle detector.

In addition, when determining whether another vehicle is starting, based on the change in distance information from the obstacle detected by the obstacle detector, the vehicle may obtain speed information of another vehicle in front and determine whether another vehicle in front starts based on the obtained speed information of another vehicle in front.

In addition, the vehicle outputs departure availability notification information when it is determined that another vehicle in front has departed.

If it is determined that the vehicle does not exist in another vehicle in front, it is determined whether the driving intention is the intention to go straight (305),

When it is determined that the driving intention is the straight-going intention, the vehicle determines whether the traffic signal of the traffic light is a straight-going traffic signal based on information on the recognized object in the image (306).

Determining intention to go straight, includes recognizing the lane based on the information on the recognized object in the image, determining whether the lane is a straight lane, and determining whether the position of the direction indicating lever is the original position.

When the vehicle determines that the traffic signal of the traffic light is not a straight traffic signal based on the information on the recognized object in the image, the vehicle outputs the stop maintenance notification information (304), and the vehicle may output departure availability notification information when it is determined that a traffic signal such as a traffic light is a straight traffic signal based on information on an object recognized in the image.

Before outputting departure availability notification information in response to the departure of another vehicle in front, the vehicle determines whether there is an image of a traffic light and a pedestrian in the image based on the information of the recognized object in the image, checks the traffic signal of the traffic light when the vehicle determines that the video of the traffic light exists, outputs stop maintenance notification information when the vehicle determines that the confirmed traffic signal is a stop traffic signal, and outputs departure availability notification information when the vehicle determines that the confirmed traffic signal is a straight traffic signal.

Also, when it is determined that there is an image of a pedestrian in the area adjacent to the vehicle in the image, the vehicle outputs stop maintenance notification information even if another vehicle in front has started and the traffic signal is a straight traffic signal, and outputs departure availability notification information when it is determined that the image of the pedestrian does not exist.

Operations 301-306 will be described with reference to FIGS. 6A and 6B.

Referring to FIG. 6A, when the vehicle is stopped at the crosswalk and when it is determined that the driving direction of the vehicle is going straight in response to the intention to go straight, the vehicle determines whether there is an image of another vehicle 2a in front of the image based on the information of the recognized object in the image. When it is determined that the image of the other vehicle 2a exists, the vehicle determines whether another vehicle in front has started. And the vehicle outputs stop maintenance notification information when it is determined that other vehicles in front are in a stopped state, and when it is determined that the other vehicle in front has departed, the departure availability notification information is output.

Before outputting departure availability notification information in response to the departure of another vehicle in front, the vehicle determines whether there is an image of a traffic light and a pedestrian in the image based on the information of the recognized object in the image, checks the traffic signal of the traffic light when it is determined that the video of the traffic light exists, and outputs stop maintenance notification information when it is determined that the confirmed traffic signal is a stop traffic signal.

Also, when it is determined that there is an image of a pedestrian in an area adjacent to the vehicle in the image, the vehicle outputs stop maintenance notification information even if another vehicle in front has started and the traffic signal is a straight traffic signal, and outputs departure availability notification information when it is determined that the image of the pedestrian does not exist, the vehicle.

With the other vehicle in front departing, when outputting departure availability notification information, the vehicle checks the traffic signal of the traffic light in the image based on the information of the recognized object in the image, and outputs stop notification information when it is determined that the confirmed traffic signal is changed from a straight traffic signal to a stop traffic signal or a stop ready traffic signal.

As shown in FIG. 6b, when it is determined that the driving direction of the vehicle is going straight in response to the intention to go straight while stopping at the intersection, the vehicle checks the traffic signal of the traffic light based on the information of the recognized object in the image. When the vehicle determines that the confirmed traffic signal is a straight traffic signal, the vehicle determines whether there is an image of the opposite vehicle 2b in front of the image based on the recognized object information. When it is determined that the image of the opposite vehicle 2b exists, the vehicle checks the driving intention of the opposite vehicle 2b and the sign information of the traffic sign based on the recognized object information. When it is determined that the confirmed sign information is the permitted left turn and the driving intention of the opposite vehicle 2b is the left turn intention, the vehicle outputs warning notification information or stop notification information.

The vehicle determines whether or not the opposite vehicle 2b in front has started, outputs warning notification information when it is determined that the opposite vehicle 2b in front is in a stopped state, and outputs stop notification information when it is determined that the opposite vehicle 2b in front has started.

When the vehicle determines that the confirmed sign information is a permitted left turn and the driving intention of the opposite vehicle 2b is the intention to go straight, the vehicle outputs departure availability notification information. Also, when the confirmed sign information is a left turn and it is determined that the driving intention of the opposite vehicle 2b is a left turn intention, the vehicle outputs departure availability notification information.

When it is determined that the intention to drive is not the intention to go straight, the vehicle determines whether the driving intention is to turn left (307). When it is determined that the driving intention is to turn left, the vehicle determines (308) whether a traffic signal of a traffic light is a left-turn traffic signal based on information on the recognized object in the image.

Determine whether you intend to turn left, includes recognizing the lane based on the information on the recognized object in the image and stopping the vehicle, which includes determining whether the lane is a turn left lane, and determining whether the position of the direction indicating lever is a position corresponding to the turn left direction.

When it is determined that the traffic signal of a traffic light is not a turn left traffic signal based on the information on the recognized object in the image, the vehicle outputs (304) stop maintenance notification information. When it is determined that the traffic signal of the traffic light is a left turn traffic signal based on the information on the recognized object in the image, vehicles can also output departure availability notification information.

Operations 307-308 will be described with reference to FIGS. 7 and 8.

When it is determined that the driving direction of the vehicle corresponding to the driving intention is the left direction or the U-turn direction, the vehicle recognizes the traffic signal of the traffic light in the image, the presence of other vehicles, and the mark information of the traffic sign, and controls the output of departure availability notification information based on the recognized traffic signal of the traffic light, the presence of other vehicles, and mark information of the traffic sign.

Referring to FIG. 7, the vehicle recognizes information about traffic signs from the image data determines whether a left turn or a U-turn is possible from the sign information on the recognized traffic sign, checks the traffic signal of the traffic light based on the recognized object information when the vehicle determines that a left turn or a U-turn is possible, and outputs departure availability notification information when the vehicle determines that the confirmed traffic signal is a left-turn traffic signal.

Before outputting the departure availability notification information, the vehicle determines whether an image of the opposite vehicle 2b in front of the image exists based on the recognized object information, confirms the driving intention of the opposite vehicle 2b based on the recognized object information when it is determined that the image of the opposite vehicle 2b exists, and outputs warning notification when it is determined that the confirmed sign information is a right turn.

Referring to FIG. 8, when the driving intention is to turn left, the vehicle recognizes the traffic sign information from the recognized object information. When the sign information on the recognized traffic sign is a permitted left turn, the vehicle checks the traffic signal of the traffic light based on the recognized object information. When it is determined that the confirmed traffic signal is a straight traffic signal (that is, the green lamp is lit), the vehicle outputs departure availability notification information.

Before outputting departure availability notification information in response to a straight traffic signal, the vehicle determines whether there is an image of the opposite vehicle 2b in front of the image based on the recognized object information, and confirms the driving intention of the opposite vehicle 2b based on the recognized object information when it is determined that the image of the opposite vehicle 2b exists, outputs warning information when it is determined that the driving intention of the confirmed opposite vehicle 2b is the intention to turn right, and outputs stop notification information when it is determined that the driving intention of the confirmed opposite vehicle 2b is the intention to go straight.

When it is determined that the opposite vehicle 2b is in a stopped state or the opposite vehicle 2b does not exist before outputting the departure availability notification information in response to the straight traffic signal, the vehicle may output departure availability notification information.

Before outputting departure availability notification information in response to a straight traffic signal, the vehicle determines whether there is an image of another vehicle 2a in front of the image based on the recognized object information, and determines whether the other vehicle 2a in the front starts or not when the vehicle determines that the image of the other vehicle 2a in front exists, and outputs departure notification information when it is determined that the other vehicle 2a in front has started.

When it is determined that the driving intention is not the intention to go straight and the intention to turn left, the vehicle determines that it is intended to turn right. The vehicle determines whether a pedestrian exists in the right-turning direction based on information on the recognized object in the image (309). When it is determined that a pedestrian is present, the vehicle outputs stop maintenance notification information (304), and when it is determined that a pedestrian does not exist, the vehicle outputs attention notification information or departure availability notification information.

Determining the intention to turn right, includes recognizing the lane based on the information on the recognized object in the image and stopping the vehicle, which includes determining whether the lane is the outermost turn-right lane, and determining whether the position of the direction indicating lever is a position corresponding to the turn-right direction.

In addition, the vehicle determines whether there is another vehicle entering in the right-turning direction based on the information on the recognized object in the image. When the vehicle determines that another vehicle exists, it outputs stop maintenance notification information, and when it is determined that the vehicle does not exist, it is possible to output attention notification information or to output departure availability notification information.

Before outputting the departure availability notification information, such a vehicle determines whether there is a pedestrian in the direction or in front of the vehicle (309), when it is determined that a pedestrian exists, the vehicle may output 310 stop notification information, and when it is determined that a pedestrian does not exist, it is also possible to output 311 departure availability notification information. This will be described with reference to FIG. 9.

As shown in FIG. 9, when the vehicle determines that the driving direction of the vehicle corresponding to the driving intention is the right direction, the vehicle determines whether there is an image of a pedestrian and at least one other vehicle (2b, 2c) in the image based on the recognized object information, when it is determined that a pedestrian or at least one other vehicle exists, the vehicle outputs stop notification information or caution notification information, and when it is determined that there is no pedestrian or at least one other vehicle, the vehicle outputs departure availability notification information.

Here, the at least one other vehicle may be another vehicle whose driving direction is the same as the own vehicle. One of the other vehicles may be the opposite vehicle 2b and may be a vehicle whose driving intention is to turn left, and the other vehicle may be a crossover vehicle 2c and may be a vehicle whose driving intention is to go straight.

The vehicle acquires position information and speed information of other vehicles 2b and 2c based on at least one of image data and detection information detected by an obstacle detector. And the vehicle may output departure availability notification information or warning notification information based on the obtained location information and speed information of the other vehicles 2b and 2c.

When it is determined that there is an image of a traffic light based on the recognized object information, the vehicle checks the traffic signal of the traffic light and when the traffic signal of the identified traffic light is judged to be a caution traffic signal (red lamp flashing or yellow lamp flashing), the vehicle can also output warning information.

After the departure availability notification information is output, the vehicle determines whether a departure intention exists (312).

Determining whether a starting intention exists includes determining whether a starting intention of the vehicle exists based on the first pressure information or the second pressure information.

More specifically, the vehicle determines whether the driver intends to accelerate based on the first pressure information detected by the first pressure detector, and when it is determined that the driver's acceleration intention exists, the vehicle may determine that the departure intention exists.

The vehicle may determine whether the driver intends to release the brake based on the pressure information detected by the second pressure detection unit, and determine that the driver's intention to release the brake exists if it is determined that there is an intention to start.

When the vehicle determines that the vehicle's intention to start is present, the vehicle re-recognizes the object based on the image data, and determines whether the traffic signal of the traffic light has changed based on information on the re-recognized object (313). When it is determined that the traffic signal has changed, the vehicle outputs stop notification information 310, and when it is determined that the traffic signal has not changed, the vehicle determines (314) the completion of passing the intersection or the crosswalk.

Determining the completion of the passing includes re-recognizing the object based on the image data and determining whether the intersection or the crosswalk has been passed based on information on the re-recognized object.

Determining the completion of the passing includes determining whether or not the vehicle has passed the stopped intersection or the crosswalk based on the navigation information and the current location information.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which can be decoded by a computer are stored, for example, a Read Only Memory (ROM), a Random Access Memory (RAM), a magnetic tape, a magnetic disk, a flash memory, an optical data storage device, and the like.

Although exemplary embodiments of the present disclosure have been described for illustrative purposes, those skilled in the art will appreciate that various modifications, additions and substitutions are possible, without departing from the scope and spirit of the disclosure. Therefore, exemplary embodiments of the present disclosure have not been described for limiting purposes.

The present disclosure prevents a collision with a pedestrian walking at an intersection or crosswalk by outputting information on the driving possibility of an intersection or crosswalk or information on the possibility of collision with other vehicles or pedestrians. Accordingly, the present disclosure can increase the safety of the vehicle and reduce the risk of traffic accidents.

In the present disclosure, it is possible to determine the possibility of driving at an intersection or crosswalk and the possibility of collision with other vehicles or pedestrians using only a camera and a detection unit in a state in which the hardware configuration is not added. Accordingly, it is possible to improve the accuracy of the determination of the possibility of driving at an intersection or crosswalk and the possibility of collision with other vehicles or pedestrians, and improve the stability of the vehicle while preventing an increase in vehicle cost.

According to the present disclosure, even if the driver does not pay attention to the situation ahead while stopping in front of an intersection or crosswalk, it is possible to increase driving convenience by notifying the departure timing.

The present invention can extend a control area by linking with a driver assistance system (ADAS) related to convenience and safety, such as Lane Follow Assist (LFA) and Autonomous Emergency Braking System (AEB).

As described above, the present disclosure can improve the quality and marketability of a vehicle having a driver assistance system and a driver assistance system, and further increase user satisfaction and secure product competitiveness.

### DESCRIPTION OF SYMBOLS

1: vehicle

100: driver assistance system

110: front camera

120: front radar

130: corner radars

131: first corner radar

132: second corner radar

133: third corner radar

134: fourth corner radar

140: first controller

200: notification apparatus

210: vision system

260: second controller

261: storage

What is claimed is:

1. A vision system, comprising:
a camera provided on a vehicle and having a front view of the vehicle outside, and configured to capture image data; and
a controller having a processor configured to process the captured image data by the camera; and
wherein the controller is configured to recognize an object existing in the front view based on the processed image data, determine whether the vehicle can depart based on information on the recognized object, control an output of departure availability notification or stop notification information corresponding to the determined departure availability.

2. The vision system of claim 1 further comprising:
a communicator configured to receive a first pressure information on the pressure applied to an accelerator pedal, and a second pressure information on the pressure applied to a brake pedal, and
wherein the controller, after controlling the output of the departure availability notification information, is configured to determine a departure intention of the vehicle based on the first pressure information and the second pressure information, and re-recognize the object based on the precessed image data when it is determined that there is the departure intention of the vehicle, and control the output of the stop notification information based on the information of the re-recognized object.

3. The vision system of claim 1 further comprising:
a communicator configured to receive lever signal; and
wherein the controller is configured to determine driving direction of the vehicle based on the received lever signal, and recognize the object based on the determined driving direction of the vehicle.

4. The vision system of claim 3,
wherein information of the recognized object includes information on at least one of other vehicles, pedestrians, traffic lights, and traffic signs, and
wherein the controller is configured to recognize an existence of the other vehicles and the pedestrians from the image data, recognize information on the traffic lights from the image data, and determine the traffic signs from information on the recognized traffic lights.

5. The vision system of claim 4, wherein the controller is configured to determine whether the other vehicle is existed in the front based on the information on the recognized object, determine whether the other vehicle in the front departs based on position change of the other vehicle in the front when it is determined that the other vehicle is existed in the front, control the output of departure availability notification information when it is determined that the other vehicle in the front is in the departure state.

6. The vision system of claim 5, wherein the communicator is configured to receive at least one of distance information from the other vehicle and speed information of the other vehicle, and
wherein the controller is configured to determine whether the other vehicle departs based on at least one of received information.

7. The vision system of claim 4, wherein the controller is configured to control the output of the departure availability notification information based on the at least one information of traffic signals of the traffic signs and the pedestrians when the driving direction of the determined vehicle is a straight direction.

8. The vision system of claim 4, wherein the controller is configured to control the output of the departure availability notification information based on the at least one information of traffic signals of the traffic signs, the other vehicles, and the traffic signs when the driving direction of the determined vehicle is the left direction or the U-turn direction.

9. The vision system of claim 8, wherein the controller is configured to recognize information of the traffic signs from the image data, and determine a timing of the left turn and a timing of the U-turn from the information on the recognized traffic signs.

10. The vision system of claim 4, wherein the controller is configured to control the output of the departure availability notification information or attention notification information based on at least one information of the other vehicles and the pedestrians when it is determined that the driving direction of the determined vehicle is the right direction.

11. A vehicle, comprising:
a camera configured to capture image of road;
a controller having a processor configured to process the captured image of road by the camera; and
an output configured to output information corresponding to a control command of the processor, and
wherein the controller is configured to recognize an object based on the image data of the processed image when in a stationary state, determine departure availability based on information on the recognized object, and control the output to output information corresponding to the departure availability.

12. The vehicle of claim 11, wherein the controller is configured to determine the stationary state at an intersection or crosswalk based on at least one of navigation information and the image data.

13. The vehicle of claim 11 further comprising:
a first pressure detector configured to output first pressure information by detecting pressure applied to an accelerator pedal; and
a second pressure detector configured to output second pressure information by detecting pressure applied to a brake pedal; and
wherein the controller, after controlling the output of the departure availability notification information, is configured to determine a departure intention of the vehicle based on the first pressure information and the second pressure information, and recognize the object based on the image data when it is determined that there is the departure intention of the vehicle, and control the output of the stop notification information based on whether the object is recognized.

14. The vehicle of claim 11 further comprising:
a lever signal receiver configured to receive lever signal of the direction indicating lever, and
wherein the controller is configured to determine the driving direction of the vehicle based on the received level signal, and recognize the object based on the determined driving direction information.

15. The vehicle of claim 11, wherein the object includes at least one of other vehicles, pedestrians, traffic lights, and traffic signs.

16. The vehicle of claim 11, wherein the output is configured to include at least one of a display configured to display information corresponding to the departure availability as an image, and a sound output configured to output information corresponding to the departure availability as sound

17. A control method of vehicle, comprising:
recognizing an object based on captured image data by a camera when the vehicle is a stationary state;
determining departure availability based on information of the recognized object;
outputting information corresponding to the departure availability;
determining whether to depart based on any one of first pressure information on the pressure applied to an accelerator pedal and second pressure information on the pressure applied to a brake pedal;
recognizing the object based on the image data when it is determined that there is a departure intention, and
outputting stop notification information based on whether the object is recognized.

18. The control method of vehicle of claim 17, wherein outputting information corresponding to the departure availability includes:
determining whether the other vehicle exists in front of the vehicle based on the recognized object information,
determining whether the other vehicle in the front departs based on at least one of distance information from the other vehicle in the front and speed information of the other vehicle in the front when it is determined that there is the other vehicle in the front;
controlling the output of departure availability notification information when it is determined that the other vehicle in the front is in the departure state.

19. The control method of vehicle of claim 17, wherein outputting the information corresponding to the departure availability includes:
determining the driving direction of the vehicle based on the operation signal of the direction indicating lever;
controlling the output of the departure availability notification information based on the traffic signal of a traffic light, information on other vehicles and traffic signs among the information on the recognized object when it is determined that the determined driving direction of the vehicle is the left direction or the U-turn direction;
controlling the output of departure availability notification information or attention notification information based on information on the other vehicle and pedestrian among the information on the recognized object when it is determined that the determined driving direction of the vehicle is the right direction.

20. The control method of vehicle of claim 17, wherein determining the stationary state of the vehicle includes:
determining the stationary state at an intersection or crosswalk based on at least one of navigation information and the image data.
